(19) United States
(12) Patent Application Publication
(10) Pub. No.: US 2004/0213959 A1
(43) Pub. Date: Oct. 28, 2004

(54) Textile fabric

(75) Inventor: Charles Chiang, Zhong Shan (CN)

Correspondence Address: BACON & THOMAS, PLLC, 625 SLATERS LANE, FOURTH FLOOR, ALEXANDRIA, VA, 22314

(73) Assignee: LOJEL PLASTIC INC., Zhong Shan (CN)

(21) Appl. No.: 10/688,884

(22) Filed: Oct. 21, 2003

(30) Foreign Application Priority Data
Apr. 28, 2003 (CN) 03251378.X

(51) Int. Cl. B32B 3/00

(52) U.S. Cl. 428/156

(57) ABSTRACT

A textile fabric for use to make luggage, bags, shoes, etc. includes a fabric base layer having a front side and a back side, and a back coating layer having a bonding side bonded to the back side of the fabric base layer and a back body side. The back coating layer is prepared from TPU (thermoplastic polyurethane), PS (polystyrene), and EVA (ethylene vinyl acetate), and coated on the fabric base layer. Either the fabric base layer or the back coating layer can be exposed to the outside when making luggage, bags, shoes, etc.

### BACKGROUND OF THE INVENTION

1. Field of the Invention

The present invention relates to a water and weather proof textile fabric and, more particularly to such a textile fabric that is suitable for use to make luggage, bags, and shoes.

2. Description of the Related Art

For the advantages of light weight and comfort touch, textile fabric is intensively used to make luggage, sports bags, backpacks, and shoes. The structural strength of a textile fabric is determined subject to the quality of the base fabric material, the diameter of the threads, the thread count, and the weaving method. Well control of these factors makes the textile fabric strong enough, preventing an excessive extension under a load. Conventionally, a piece of textile product is made by directly cutting a cloth of fabric subject to a predetermined pattern and then making the cut piece of fabric into the finished product by stitching. A textile product made according to this method is not highly acceptable to consumers because it cannot protect the user against water and strong wind. In order to improve this drawback, a back coating layer may be coated on the back side of the fabric, i.e., to form a thin layer of polymeric substance on the fabric, or to coat the fabric with a layer of synthetic material. The back coating layer protects against water, reinforces the strength of the fabric, and gives a comfort touch. If to make the product elastic (calenderable), the polymeric coating must be elastic, i.e., stretchable. This kind of polymeric coating can be prepared from a polymeric material of monomer type. Normally, copolymers of different types of monomers are synthesized to provide the desired properties. Further, softener may be added to enhance the softness and flexibility of the polymeric material.

Among polymers, the following materials are commonly used for making the aforesaid back coating layer: PVC (polyvinyl chloride) and its copolymers, polyacrylate and its copolymers, PA (polyamide), synthetic rubber and its copolymers, and silicon rubber. During evaporation of solvent in the system, polymeric material dissolved or dispersed in organic solvent forms a continuous film of polymers. Alternatively, the polymeric material can be applied to the fabric as water dispersion element. When water evaporated from dispersion element, a continuous polymeric film is formed on the fabric. If thermoplastic polymer is used, it can be applied to the fabric when melted.

According to conventional technology, PVC is commonly used for making a back coating on a fabric. However; because PVC generates dioxin and other toxic gasses when burnt, it is harmful to the environment and human beings. Therefore, the use of PVC to make a back coating on a fabric is gradually prohibited. Further, PVC material is relatively heavy, not suitable for making luggage, bags, and shoes of light weight.

PE (polyethylene), EVA (ethylene-vinyl-acetate copolymer), or the mixture of PE and EVA may be used for making a back coating for fabric. However, these materials have the properties of plastics, i.e., the drawbacks of high hardness and rigidity. A fabric coated with a back coating of one of these materials is less flexible, and tends to wrinkle. Therefore, the aforesaid materials are not commonly used fabric materials for making luggage, bags, and shoes.

Therefore, it is desirable to provide a textile fabric of low pollutant, high softness and elasticity, and good waterproof property.

### SUMMARY OF THE INVENTION

The present invention has been accomplished under the circumstances in view. It is therefore the main object of the present invention to provide a textile fabric, which is soft, elastic, and water proof, and practical for use to make luggage, bags, and shoes.

According to the present invention, the textile fabric comprises a fabric base layer and a back coating layer. The fabric base layer is made from nylon or polyester, having a front side and a back side. The back coating layer has a bonding side bonded to the back side of the fabric base layer, and a back body side. The back coating layer is prepared from TPU (thermoplastic polyurethane), PS (polystyrene), EVA (ethylene vinyl acetate), processing oil, plastics, and additives subject to a predetermined formula.

A bonding layer may be selectively used and bonded between the fabric base layer and the back coating layer. The bonding layer has a first side bonded to the back side of the fabric base layer, and a second side bonded to the bonding side of the back coating layer. Preferably, the bonding layer is prepared from PMMA (polymethyl methacrylate), viscosity index improver, additives, and toluene.

Comparing to conventional methods, the invention uses TPU (thermoplastic polyurethane), PS (polystyrene) and EVA (ethylene vinyl acetate) to substitute for polyvinyl chloride, reducing possible pollution to environment. Further, the back coating layer prepared from the aforesaid materials is soft and elastic, not easy to wrinkle, and more particularly, water proof. When using the textile fabric to make luggage, bags, shoes, etc., either the fabric base layer or the back coating layer can be exposed to the outside.

### BRIEF DESCRIPTION OF THE DRAWINGS

FIG. 1 is a sectional view of a textile fabric constructed according to the present invention.

FIG. 2 is a block diagram showing the textile fabric fabrication flow according to the present invention.

FIGS. 3A and 3B are schematic drawings showing the bonding layer processing and back coating processing according to the present invention.

### DETAILED DESCRIPTION OF THE INVENTION

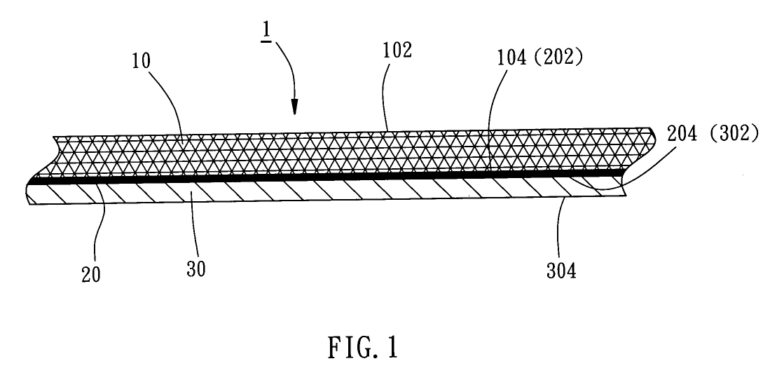

Referring to FIG. 1, a textile fabric 1 is shown comprising a fabric base layer and a back coating layer 30.

The fabric base layer 10 is made from nylon or polyester, having a front side 102 and a back side 104.

A bonding layer 20 may be selectively provided between the fabric base layer 10 and the back coating layer 30. The bonding layer 20 has a first side 202 and a second side 204. The first side 202 is bonded to the back side 104 of the fabric base layer 10. The bonding layer 20 may be prepared by means of one of various known processing methods and subject to one of various known formulas. Preferably, the bonding layer 20 is prepared from PMMA (polymethyl methacrylate), viscosity index improver, additives, and toluene.

The back coating layer 30 has a bonding side 302 and a back body side 304. If the aforesaid bonding layer 20 is not used, the bonding side 302 is bonded to the back side 104 of the fabric base layer 10. In case the aforesaid bonding layer 20 is used, the bonding side 302 is bonded to the second side 204 of the bonding layer 20. The material for the back coating layer 30 is prepared from TPU (thermoplastic polyurethane), PS (polystyrene), EVA (ethylene vinyl acetate), processing oil (long chain dihydric alcohols, short chain dihydric alcohols), plastics, and additives subject to a predetermined proportion, and then applied to the fabric base layer 10 (or applied to the bonding layer 20 if the bonding layer 20 is used) by means of any of a variety of processing methods (this will be described further).

When using the textile fabric 1 to make luggage, bags, shoes, etc., the front side 102 of the fabric base layer 10 or the back body side 304 of the back coating layer 30 can be exposed to the outside.

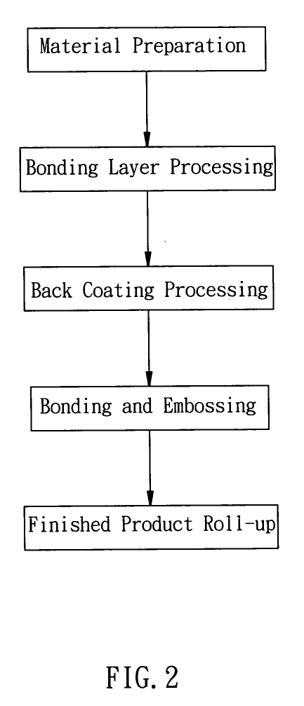

Referring to FIG. 2, the fabrication of the textile fabric 1 includes the steps of material preparation, bonding layer processing, back coating processing, bonding and embossing, and finished product roll-up. The steps of material preparation, bonding and embossing, and finished product roll-up are similar to the conventional textile fabric fabrication methods. The steps of bonding layer processing and back coating processing are outlined hereinafter.

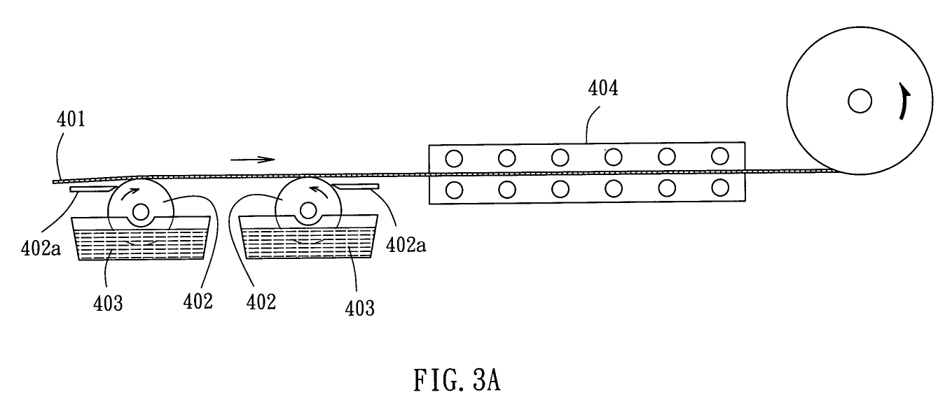

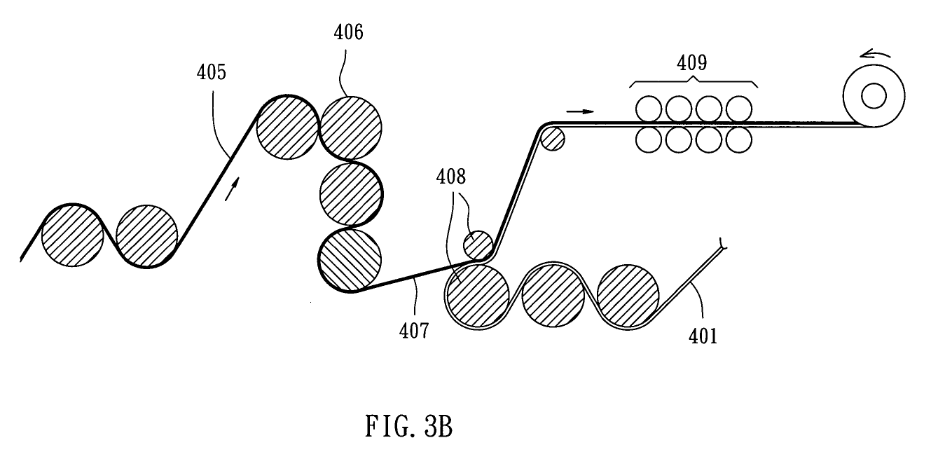

As shown in FIG. 3A, a continuous sheet of fabric 401 (i.e., the aforesaid fabric base layer) is delivered over applicator wheels 402 that apply a bonding agent 403 to one side of the fabric 401, and at the same time scrappers 402a remove excessive bonding agent 403 from the periphery of the applicator wheels 402. The bonding agent coated fabric 401 is then delivered through a baking oven 404 and dried, and then the well dried bonding agent coated fabric 401 is rolled up for further use. The bonding agent 403 is obtained from a mixture containing PMMA, viscosity index improver (0˜120HPR), additives (0˜20PHR), and toluene (100˜500PHR).

Thereafter, prepare a back coating material 405 containing TPU, PS, EVA (100PHR), processing oil (0˜120PHR), plastics (0˜100PHR), and additives (0˜20PHR). The prepared back coating material 405 is mixed by a screw and then melted (melting index over 3 g/min), and then rolled by a set of hot rollers 406 into a sheet of back coating 407 at temperature within about 90˜160° C., as shown in FIG. 3B, and then the sheet of back coating 407 and the bonding agent 403 coated fabric 401, which is preheated, are bonded together through a set of impression rollers 408, and then the textile fabric thus obtained is delivered through a set of cooling rollers 409 and cooled down. The surface of the back coating layer, i.e. the back coating 407, is embossed when it passes through the impression rollers.

While only one embodiment of the present invention has been shown and described, it will be understood that various modifications and changes could be made thereunto without departing from the spirit and scope of the invention.

What is claimed is:

1. A textile fabric comprising a fabric base layer having a front side and a back side, and a back coating layer having a bonding side bonded to the back side of said fabric base layer and a back body side, said back coating layer being prepared from TPU (thermoplastic polyurethane), PS (polystyrene), and EVA (ethylene vinyl acetate), and coated on said fabric base layer.

2. The textile fabric as claimed in claim 1, wherein said fabric base layer is made from a material selected from a group consisting of nylon and polyester.

3. The textile fabric as claimed in claim 1, further comprising a bonding layer bonded between said fabric base layer and said back coating layer.

4. The textile fabric as claimed in claim 3, wherein said bonding layer has a first side bonded to the back side of said fabric base layer, and a second side bonded to the bonding side of said back coating layer.

5. The textile fabric as claimed in claim 4, wherein said bonding layer is prepared from PMMA (polymethyl methacrylate), viscosity index improver, additives, and toluene.

6. The textile fabric as claimed in claim 1, wherein said back coating layer is prepared from said TPU, said PS, said EVA, and a processing oil obtained from long chain dihydric alcohols or short chain dihydric alcohols.

7. The textile fabric as claimed in claim 6, wherein said back coating layer is prepared from said TPU, said PS, said EVA, said processing oil, and additives.

8. The textile fabric as claimed in claim 7, wherein said back coating layer is embossed.
